(19) United States
(12) Patent Application Publication
(10) Pub. No.: US 2003/0049583 A1
(43) Pub. Date: Mar. 13, 2003

(54) Pre-emergent tooth correction method and assembly

(76) Inventors: Lewis H. Pitnick, Boca Raton, FL (US); Denis R. Slawsby, Scottsdale, AZ (US); Jeffrey Sakoff, Boynton Beach, FL (US)

Correspondence Address: REISING ETHINGTON BARNES KISSELLE, LEARMAN AND MCCULLOCH PC, P O BOX 4390, TROY, MI, 48099-4390, US

(21) Appl. No.: 10/284,758

(22) Filed: Oct. 31, 2002

Related U.S. Application Data
(63) Continuation-in-part of application No. 10/236,419, filed on Dec. 11, 2002.
(60) Provisional application No. 60/317,570, filed on Sep. 6, 2001.

(51) Int. Cl. A61C 3/00

(52) U.S. Cl. 433/18; 433/9

(57) ABSTRACT

A pre-emergent tooth correction method and assembly for applying traction to a pre-emergent tooth to cause the tooth to erupt in a desired position. A bonding pad is surgically affixed to an outer surface of a pre-emergent tooth. A chain is attached at one end to the bonding pad and at a second end to a traction device. The bonding pad includes a stainless steel mesh comprising a non-allergenic metal.

### CROSS REFERENCE TO RELATED APPLICATION

This application is a Continuation in Part of a non-provisional application filed Sep. 6, 2002 and claims priority from Provisional Application No. 60/317,570, filed Sep. 6, 2001 and titled PRE-EMERGENT TOOTH CORRECTION METHOD AND ASSEMBLY, which is incorporated by reference.

### TECHNICAL FIELD

This invention relates generally to a pre-emergent tooth correction method and assembly for applying traction to a pre-emergent tooth to cause the tooth to erupt in a desired position.

### BACKGROUND OF THE INVENTION

It is known to correct a pre-emergent tooth by surgically affixing a bonding pad to the tooth and applying traction to cause the tooth to erupt in a desired position. The bonding pad is affixed to an outer surface of the tooth and a chain is attached at one end to the bonding pad and at a second end to an orthodontic appliance via attachment means such as an archwire, a spring, elastic or another force-applying component.

For example, The Xemax Cusp-Lok™ is a pre-emergent tooth correction system that includes a bonding pad configured to be surgically affixed to an outer surface of a pre-emergent tooth. The Cusp-Lok™ system also includes a gold chain that is pre-attached at one end to the bonding pad by soldering and is configured to be attached at a second end to an orthodontic appliance. The bonding pad of at least one model of the Cusp-Lok™ includes a mesh comprising stainless steel that includes Nickel.

Stainless steel is a well-known selection for such applications because it's durable, and has an acceptably high tensile and yield strength. In temporary applications, stainless steel is generally well tolerated when in close apposition to body tissues. By definition, however, this alloy unavoidably contains a proportion of nickel as well as other trace metal elements. Nickel has a tendency to leach into the saliva within the oral cavity. A significant segment of the patient population (0.3 percent to 0.5 percent) cannot tolerate this chemical intrusion, which can cause toxic or allergic reactions.

U. S. Pat. No. 5,947,723 issued Sep. 7, 1999 to Mottate et al., discloses the use a titanium alloy in an orthodontic application. The titanium alloy is formulated to avoid allergic reactions and cell toxicity problems in patients. However, the bonding pad disclosed in the Mottate et al. patent is configured to be adhesively affixed to a post-emergent, rather than a pre-emergent tooth and doesn't include a pre-attached chain.

Another known titanium formulation is “commercially pure” titanium. ASTM grades 1-4 of this form of titanium are known in the medical and dental fields as being biocompatible alloys. ASTM grades 1-4 are preferred for applications where purity is the most important attribute. ASTM grade 1 commercially pure titanium has the greatest degree of purity and is therefore least likely to cause adverse or allergic reactions in a human body. Of the four biocompatible grades, grade four has the highest tensile and yield strength.

| | Min Tensile (KSI) | Min Yield (KSI) |
|---|---|---|
| Grade 1 | 35 | 25 |
| Grade 4 | 80 | 70 |

The human body tolerates commercially pure titanium well. Commercially pure titanium degrades slowly enough that it is used in implanted medical devices such as orthopedic screws, cardiac pacemakers and dental implants. It's generally recognized as being non-toxic and non-allergenic. In addition, bone stem cells are known to have an affinity to titanium molecules at the cellular level. One reason that titanium is not a well-known solution to dental applications is that it is difficult to fabricate small, delicate parts from titanium. For example, when heated, titanium forms an outer oxide layer that can make soldering and welding extremely difficult if not impossible except under controlled conditions.

What is needed a pre-emergent tooth correction assembly that can apply traction to a pre-emergent tooth in a patient without introducing toxins into the patient's oral cavity. What is also needed is a method for fabricating such an assembly.

### SUMMARY OF THE INVENTION

A pre-emergent tooth correction assembly is provided for applying traction to a pre-emergent tooth to cause the tooth to erupt in a desired position. The assembly includes a bonding pad configured to be surgically affixed to an outer surface of a pre-emergent tooth. A chain is pre-attached at one end to the bonding pad and is configured to be attached at a second end to a traction device. The bonding pad includes a mesh comprising a non-allergenic, non-toxic metal. This prevents toxins from being leached from the metal.

According to another aspect of the invention, the pad comprises titanium.

According to another aspect of the invention, the pad comprises commercially pure titanium.

According to another aspect of the invention, the pad comprises ASTM grade 1 commercially pure titanium.

According to another aspect of the invention, the chain comprises nickel-free gold.

According to another aspect of the invention, the chain comprises commercially pure titanium. A totally titanium appliance eliminates the possibility of toxins being leached from the metal.

According to another aspect of the invention, the chain comprises ASTM grade 4 commercially pure titanium.

According to another aspect of the invention, a Nickel-free gold solder joint holds the gold chain and titanium mesh together.

According to another aspect of the invention, the titanium chain is welded to the titanium mesh.

According to another aspect of the invention, the chain is affixed to the pad with an adhesive such as an epoxy.

The invention also includes a method for applying traction to a pre-emergent tooth to cause the tooth to erupt in a desired position. According to this method one can applying traction to a pre-emergent tooth by surgically exposing a malpositioned pre-emergent tooth, by cutting tissue surrounding the tooth and affixing a bonding agent to one of the tooth and the bonding pad. The bonding pad is then bonded to the tooth and the surrounding tissue is surgically closed over the tooth such that the chain extends through the surrounding tissue. The free end of the chain is then attached to an orthodontic appliance.

According to another aspect of the inventive method, the step of attaching the free end of the chain to an orthodontic appliance includes attaching the free end of the chain to a traction device.

The invention also includes a method for making a pre-emergent tooth correction assembly. The method includes providing a bonding pad comprising commercially pure titanium, fabricating the chain and affixing one end of the chain to the bonding pad.

According to another aspect of the inventive method the step of providing the bonding pad includes providing a bonding pad made of ASTM grade 1 commercially pure titanium.

According to another aspect of the inventive method, the step of fabricating the chain includes fabricating the chain from nickel-free gold.

According to another aspect of the inventive method the step of affixing one end of the chain to the bonding pad includes soldering the chain to the pad using nickel-free gold solder.

According to another aspect of the inventive method the step of affixing one end of the chain to the bonding pad includes soldering the gold chain to the titanium pad in an oven having an atmosphere of inert gas.

According to another aspect of the inventive method, the step of affixing one end of the chain to the bonding pad includes welding the titanium chain to the titanium pad.

According to another aspect of the inventive method, the step of affixing one end of the chain to the bonding pad includes flash or resistance welding the titanium chain to the titanium pad. Flash welding will accomplish the weld before the titanium can oxidize sufficiently to prevent the weld.

According to another aspect of the inventive method, the step of affixing one end of the chain to the bonding pad includes adhering the chain directly to the pad using a bonding agent such as an epoxy. The chain is positioned relative to the pad and then the bonding agent is injected onto the chain and grid and allowed to cure.

According to another aspect of the inventive method, an applicator ring is affixed to the mesh. The applicator ring serves as a handle that a surgeon can easily grasp with a clamping instrument.

### BRIEF DESCRIPTION OF THE DRAWINGS

These and other features and advantages of the invention will become apparent to those skilled in the art in connection with the following detailed description and drawings, in which:

FIG. 1 is a front view of a pre-emergent tooth correction assembly constructed according to the invention;

FIG. 2 is a front view of the tooth correction assembly of FIG. 1 attached to a pre-emergent tooth before surgical closure;

FIG. 3 is a front view of the tooth correction assembly of FIG. 1 attached to a pre-emergent tooth after surgical closure;

FIG. 4 is a front view of a pre-emergent tooth correction assembly constructed according to an alternative and preferred embodiment of the invention; and

FIG. 5 is a side view of the pre-emergent tooth correction assembly of FIG. 4.

### DETAILED DESCRIPTION OF INVENTION EMBODIMENT(S)

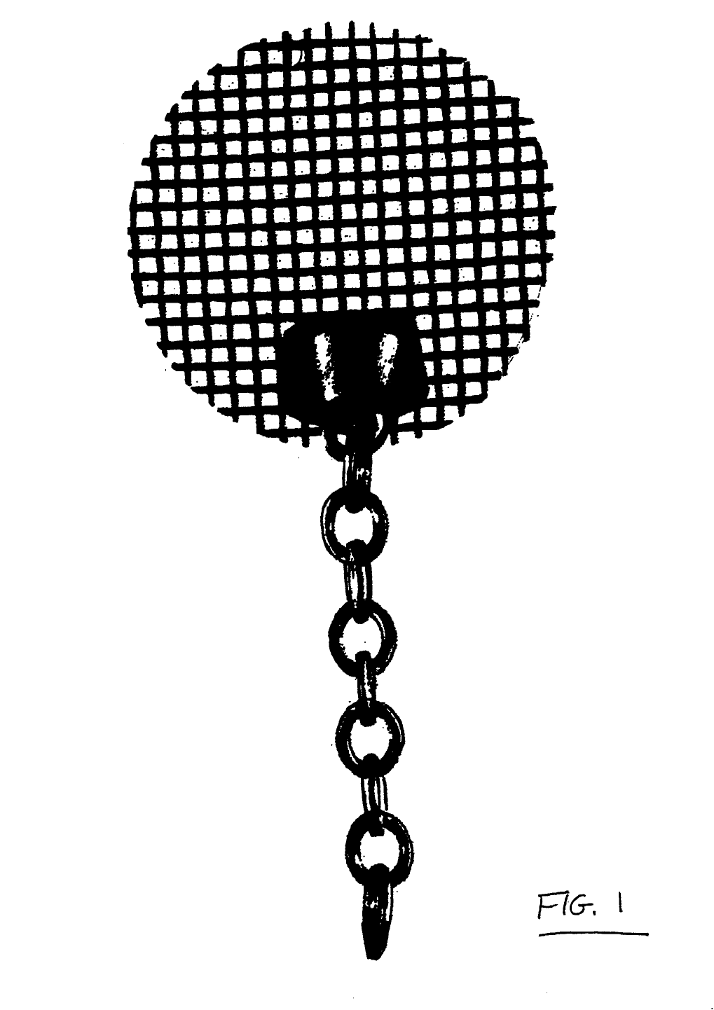

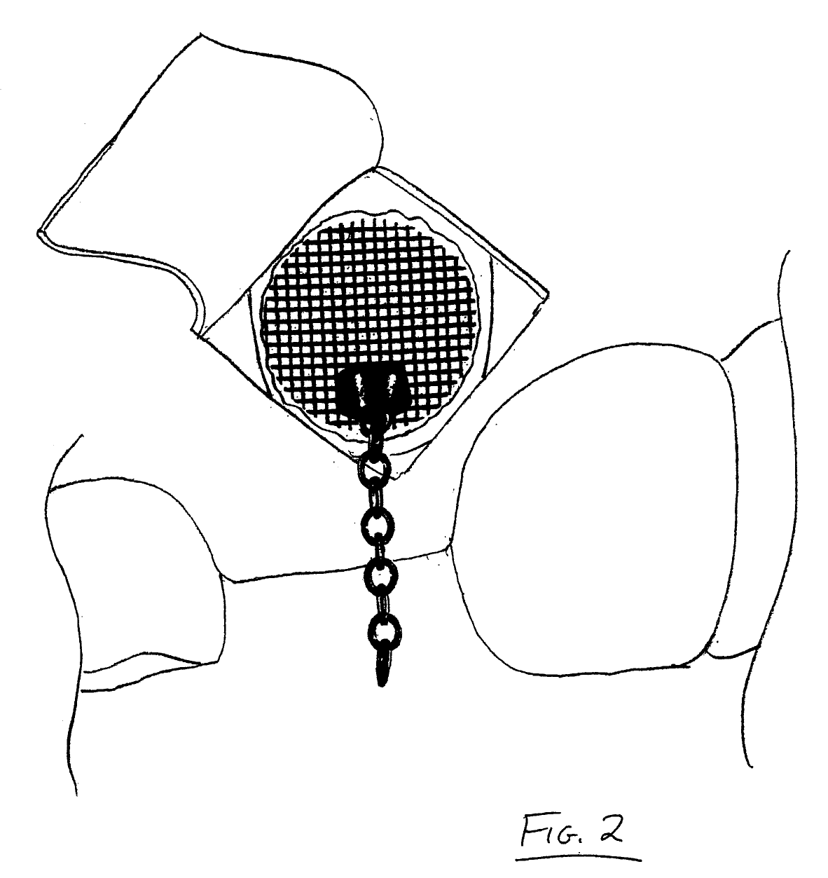

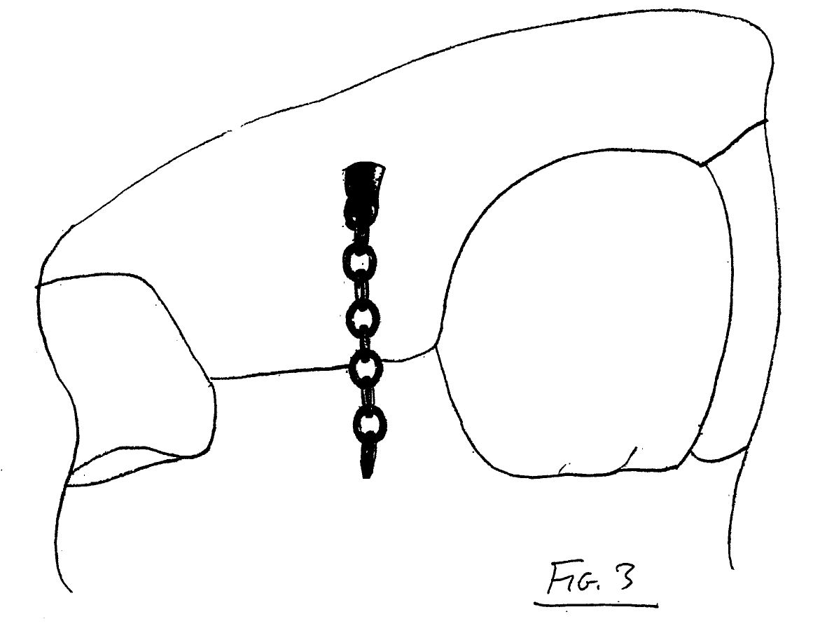

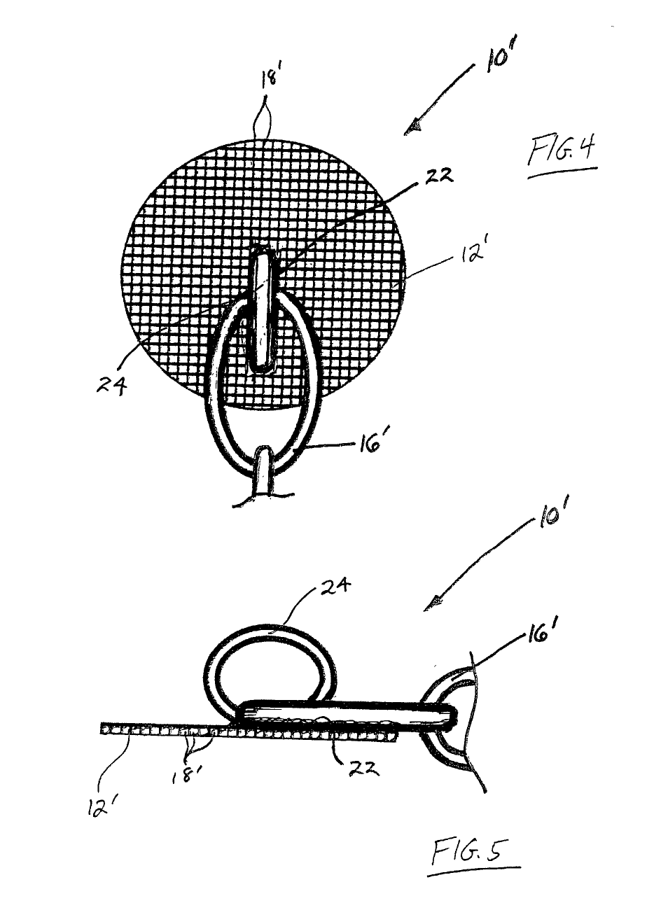

A first embodiment of a pre-emergent tooth 14 correction assembly 10 for applying traction to a pre-emergent tooth 14 is shown at 10 in FIGS. 1-3. A second embodiment of such an assembly is shown at 10′ in FIGS. 4 and 5. Unless stated otherwise, description of elements of the first embodiment applies equally to description of corresponding elements of the second embodiment designated by the same reference numerals as the corresponding elements of the first embodiment but including a prime (′) designation.

The assembly 10 includes a bonding pad 12 that is surgically affixed to an outer surface of a pre-emergent tooth 14. A chain 16 is pre-attached at one end to the bonding pad 12 and is attached at a second end to a traction device. The bonding pad 12 includes a mesh or fabric comprising a non-allergenic metal.

The non-allergenic metal used to fabricate the pad 12 may be titanium, and, more specifically, may be commercially pure titanium. Preferably, the pad 12 is made entirely of ASTM grade 1 commercially pure titanium.

The mesh that the bonding pad 12 is formed from is fabricated in a weaving machine. The weaving machine weaves together strands 18 of 0.004″ diameter titanium wire to form a size 120 mesh. 0.156″ in diameter circular or disc-shaped pads 12 are then stamped from a sheet of the titanium mesh. The mesh is commercially available from TWP of California under product designation 120X.004. In other embodiments the pad 12 may have a larger or a smaller diameter, and may be other than circular. In addition, the mesh size and wire diameter may differ.

The chain 16 comprises nickel-free 14K gold. This alloy is processed in a forming machine that bends gold wire into small loops then links the loops together. The linked loops are then placed into an oven where they are soldered closed. In other embodiments, the loops may be formed from commercially pure titanium wire. Preferably, when made of titanium, the chain 16 is made entirely of ASTM grade 4 commercially pure titanium. The following is the chemical composition of ASTM grade 4 commercially pure titanium: (Values are maximum weight %)

Oxygen: 0.40

Nitrogen: 0.05

Carbon: 0.08

Iron: 0.50

Hydrogen: 0.015

Residual elements: each 0.10

Residual elements: total 0.40

Titanium: Remainder

Typical Mechanical Properties:

Ultimate Tensile Strength (UTS): 99 ksi or 680 MPa

0.2% Yield Strength: 81 ksi or 560 MPa

Elongation: 23%

When the chain 16 is made of nickel-free 14K gold, a nickel-free 14K gold solder 20 may be used to solder the gold chain 16 and titanium mesh together. This solder is commercially available from Stern Leach of Attleboro, Mass.

When both the bonding pad 12 and the chain 16 are made of commercially pure titanium, the titanium chain 16 may be welded to the titanium mesh.

According to the second embodiment, and as shown in FIGS. 4 and 5, the chain 16 is preferably connected to the mesh by an epoxy 22 available from Master Bond under the product designation EP3HTMED. Also according to the embodiment of FIGS. 4 and 5, an applicator ring 24 is affixed to the mesh—preferably using the same epoxy 22 used to affix the chain 16 to the mesh. In other embodiments, any suitable adhesive may be used to connect the chain and the applicator ring 24 to the mesh.

According to the invention, a pre-emergent tooth 14 correction assembly 10 can be made by first forming the bonding pad 12 of commercially pure titanium, and preferably ASTM grade 1 commercially pure titanium. The chain 16 is then fabricated of nickel-free gold. However, in other embodiments, the chain 16 may instead be fabricated of commercially pure titanium—preferably ASTM grade 4 commercially pure titanium. One end of the chain 16 is then affixed to the bonding pad 12.

Where the chain 16 is made of gold, it may be soldered to the pad 12 using nickel-free gold solder. This is accomplished by positioning the solder, mesh and chain 16 together in a fixture then placing the fixture in an oven at a controlled temperature and in an atmosphere of inert gas. The inert gas prevents the titanium of the mesh from oxidizing and inhibiting the soldering operation.

Where the chain 16 is made of titanium, it may be welded to the titanium pad 12. The weld is accomplished using resistance welding to cause the titanium of the chain 16 and mesh to flow before the titanium oxidizes sufficiently to significantly impede the formation of a strong weld.

Regardless of chain 16 and mesh composition, however, the chain 16 and mesh are preferably joined by adhering the chain 16 directly to the pad 12 using a bonding agent such as an epoxy 22 as described above. The mesh and chain 16 are positioned in a fixture and then the bonding agent is injected onto the chain 16 and grid and allowed to cure. Application of bonding agent is preferably accomplished by a precision injector that provides a precise amount of bonding agent precisely in a desired position contacting both the chain 16 and the pad 12 in the fixture. Such an injector is manufactured by and is available from EFD Inc. of East Providence, R.I.

In practice, after treatment planning between a Maxillofacial Oral Surgeon and an Orthodontist, traction is applied to a malpositioned pre-emergent tooth 14 by first having the surgeon surgically expose the tooth 14 (generally a molar or cuspid). The surgeon exposes the tooth 14 by cutting some of the tissue that surrounds and encases it. A bonding agent is then applied to either the tooth 14 or the bonding pad 12 and the pad 12 is bonded onto the buccal or lingual surface of the tooth 14. Where the assembly 10 includes an applicator ring 24, the ring 24 is fixed to the bonding pad 12 and the surgeon lifts and moves the assembly 10 by grasping the applicator ring 24 using a clamping instrument. After applying the assembly 10 to the exposed tooth 14, the surgeon closes the surrounding tissue over the tooth 14 such that the chain 16 extends through the surrounding tissue.

The surgeon then refers the patient to an orthodontist. The orthodontist connects the free end of the chain 16 to an orthodontic appliance. In connecting the free end of the chain 16 to an orthodontic appliance, the orthodontist may include in the assembly 10 any one or more of a number of different types of known traction devices. Over a period of time, the orthodontist monitors and periodically adjusts the assembly 10 to maintain proper traction until the tooth 14 emerges into its natural physiologic position.

This description is intended to illustrate certain embodiments of the invention rather than to limit the invention. Therefore, it uses descriptive rather than limiting words.

Obviously, it's possible to modify this invention from what the description teaches. One may practice the invention other than as described.

What is claimed is:

1. A pre-emergent tooth correction assembly for applying traction to a pre-emergent tooth to cause the tooth to erupt in a desired position, the assembly comprising:
a bonding pad configured to be surgically affixed to an outer surface of a pre-emergent tooth;
a chain pre-attached at one end to the bonding pad and configured to be attached at a second end to a traction device; and
the bonding pad includes a stainless steel mesh comprising a non-allergenic metal.

2. A pre-emergent tooth correction assembly as defined in claim 1 in which the pad comprises titanium.

3. A pre-emergent tooth correction assembly as defined in claim 2 in which the pad comprises commercially pure titanium.

4. A pre-emergent tooth correction assembly as defined in claim 3 in which the pad comprises grade 1 commercially pure titanium.

5. A pre-emergent tooth correction assembly as defined in claim 1 in which the chain comprises nickel-free gold.

6. A pre-emergent tooth correction assembly as defined in claim 1 in which the chain comprises commercially pure titanium.

7. A pre-emergent tooth correction assembly as defined in claim 6 in which the chain comprises grade 4 commercially pure titanium.

8. A pre-emergent tooth correction assembly as defined in claim 1 in which:
the pad comprises a titanium mesh;
the chain comprises nickel-free gold; and
the assembly includes nickel-free gold solder connecting together the gold chain and titanium mesh.

9. A pre-emergent tooth correction assembly as defined in claim 1 in which the chain is welded to the pad.

10. A pre-emergent tooth correction assembly as defined in claim 1 in which the chain is bonded to the pad using an adhesive.

11. A pre-emergent tooth correction assembly as defined in claim 10 in which the adhesive is an epoxy.

12. A method for applying traction to a pre-emergent tooth to cause the tooth to erupt in a desired position, the method including the steps of:
surgically exposing a malpositioned pre-emergent tooth by cutting tissue surrounding the tooth;
affixing a bonding agent to one of the tooth and the bonding pad;
providing the bonding pad on the tooth such that the bonding agent contacts both the tooth and the bonding agent;
allowing the bonding agent to cure; and
surgically closing the surrounding tissue over the tooth such that the chain extends through the surrounding tissue.

13. The method of claim 12 including the additional step of attaching the free end of the chain to an orthodontic appliance.

14. The method of claim 12 including the additional step of surgically closing the surrounding tissue over the tooth such that the chain extends through the surrounding tissue includes attaching the free end of the chain to a traction device.

15. The method of claim 12 in which the step of providing the bonding pad on the tooth includes:
affixing an application ring to the pad; and
picking up and moving the pad into position on a pre-emergent tooth by grasping and lifting the assembly by the application ring.

16. A method for making a pre-emergent tooth correction assembly, the method including the steps of:
providing a bonding pad configured to be bonded to the outer surface of a pre-emergent tooth;
fabricating a chain; and
affixing one end of the chain to the bonding pad.

17. The method of claim 15 in which the step of providing the bonding pad includes providing a bonding pad made of commercially pure titanium.

18. The method of claim 15 in which the step of providing the bonding pad includes providing a bonding pad made of grade 1 commercially pure titanium.

19. The method of claim 15 in which the step of fabricating the chain includes fabricating the chain from nickel-free gold.

20. The method of claim 15 in which the step of affixing one end of the chain to the bonding pad includes soldering the chain to the pad using nickel-free gold solder.

21. The method of claim 19 in which the chain is soldered to the pad in an oven having an atmosphere of inert gas.

22. The method of claim 15 in which the step of affixing one end of the chain to the bonding pad includes adhering the chain directly to the pad using a bonding agent.

23. The method of claim 21 in which the chain is adhered to the pad using an epoxy.

24. The method of claim 15 including the additional steps of:
positioning the chain in a desired position relative to the pad;
providing the bonding agent on the chain and grid; and
allowing the bonding agent to cure.

25. The method of claim 23 in which the step of providing the bonding agent on the chain and grid includes using a precision injector to deposit the bonding agent.

26. The method of claim 15 in which the application ring is affixed to the pad using an adhesive.
